(19) United States
(12) Patent Application Publication
(10) Pub. No.: US 2019/0183281 A9
(43) Pub. Date: Jun. 20, 2019

(54) Valve Regulated Beverage Brewer

(71) Applicant: Fox Run USA LLC, Ivyland, PA (US)

(72) Inventors: Jennifer Tuetken, Pella, IA (US); Daniel Sosa, Philadelphia, PA (US)

(73) Assignee: Fox Run USA LLC, Ivyland, PA (US)

(21) Appl. No.: 15/698,032

(22) Filed: Sep. 7, 2017

Related U.S. Application Data
(60) Provisional application No. 62/384,466, filed on Sep. 7, 2016.

(51) Int. Cl. A47J 31/02; A47J 31/06; A47J 31/44

(52) U.S. Cl. CPC A47J 31/02; A47J 31/446; A47J 31/0621; A47J 31/0605

(57) ABSTRACT

The present invention is directed to a device for brewing beverages in which the rate of flow of brew liquid through a brewing media and filtration media is precisely and consistently controlled in an analog fashion.

### CROSS REFERENCE TO RELATED APPLICATION(S)

This application claims the benefit of U.S. Provisional Application No. 62/384,466 filed Sep. 7, 2016.

### FIELD OF THE INVENTION

The present invention relates to beverage brewing devices, specifically to devices that provide for brewing for a single cup of the brewed beverage.

### BACKGROUND OF THE INVENTION

Beverage brewing devices are well known in the art, including devices that provide for brewing a single cup of brewed beverage at a time. Presently, there are a number of such devices available, most of which need to be used with a stand that allows for the brewing device to sit over the top of the cup. Some of these devices allow for control of the flow of the brewed liquid, but there exists the need for a single cup brewing device that can sit directly on the cup to be filled and that provides for maximum control by the user of the flow of brewed liquid and consequent fine tuning of the flavor, texture, strength, and balance of the brewed beverage.

### SUMMARY OF THE INVENTION

According to the present invention, the foregoing and other objects and advantages are obtained by utilizing an internal valve mechanism in the device that controls flow of the brewed beverage. The user rotates the brewer or a portion of the brewer to change the valve setting which allows for analog adjustment of flow. The mechanism consists of two or more mating surfaces by which the spacing between can be varied by the user to adjust from full closure to a relative minimum flow to a relative maximum flow, hence, a fully analog spectrum of control.

In a second embodiment, the two or more mating surfaces are deformable membranes, manipulated directly or indirectly by the user to create an aperture or apertures of variable size.

In another embodiment, actuation of a disk or plate pivotally attached to the body of the device causes the overlap of perforations shaped in a way that the surface area of aligned perforations constitutes a continuous and uninterrupted range from a relative minimum overlap to a relative maximum overlap. All of the disclosed embodiments allow for the analog control, rather being limited to distinct, or digitally determined, flow as in the prior art.

This flow adjusting feature of the instant invention is constructed in such a way that the rate of change of flow is non-linear to the adjustment of the valve so that the actual rate of flow through the device at a given setting is optimized. This allows for precision adjustments over a portion of the adjustment range, and rapid flow over another portion without the need for a variable thread pitch or cam profile. This acceleration of flow allows for extreme fine tuning of the balance, strength, texture, and flavor of the brewed beverage.

The device is constructed as shown in the figures of this specification so that it is susceptible to disassembly for direct cleaning of all sealing surfaces because there are no permanently affixed movable mating surfaces as in prior art devices.

Additionally, the use in one embodiment of non-rigid molded material for the pair of mating surfaces that function as a valve allows for maximum control. Non-rigid material also constitutes a significant percentage of the overall device. In the preferred embodiment, silicone that is used in the manufacture of the cone is also used to wrap down into the core and form the valve structure, preventing plastic contact of the brewing liquid and preventing seams that are not hygienic between non-uniform materials.

The use of a non-rigid material in one embodiment creates a non-slip, non-marring point of contact with external objects, such as the cup on which the device is placed during or between uses. Importantly, the fully adjustable flow device of the instant invention is able to function while resting directly on a cup in each embodiment, in opposition to many products in the prior art technology that require a stand for the device to be set over the cup.

### BRIEF DESCRIPTION OF THE DRAWINGS

The invention will become more readily apparent from the following description of preferred embodiments thereof shown, by way of example only, in the accompanying drawings wherein:

FIG. 1 is a cutaway view of the device of the instant invention in its initial position prior to the commencement of brewing in which the valve is completely closed to allow for the filling of heated liquid into the device.

FIG. 2 is a cutaway view of the device of the instant invention showing the opening of the valve for control of brewing and outflow of brewed liquid.

### DETAILED DESCRIPTION OF THE INVENTION

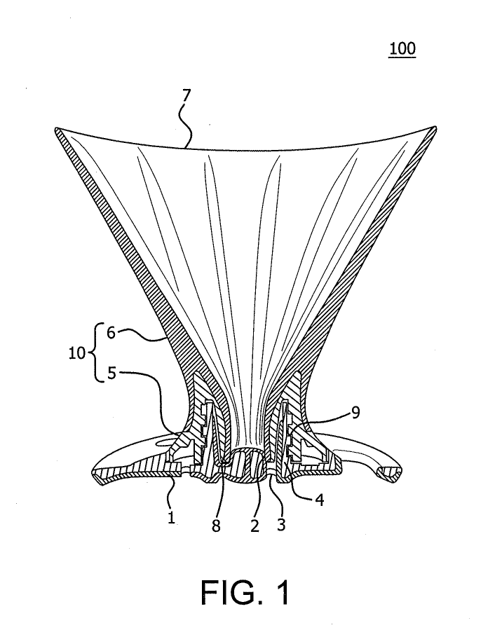

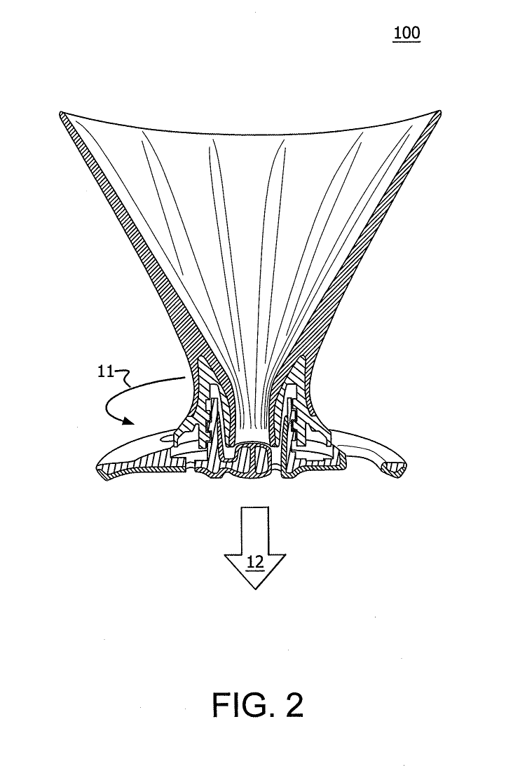

As shown in FIG. 1, the instant device 100 consists of a non-slip base 1 with a centrally located sealing mechanism 2 having an opening that is composed of radially arrayed openings 3 and fitted with a bung (or stopper) 4. The device 110 has a collar 5 and a container 6, which container is shown as a cone in the preferred embodiment that opens at its top for housing a filter (in the preferred embodiment a conical filter, also not shown) that is to be filled with a brewing media, such as coffee grounds or loose tea, and thereafter heated water is to be poured into the container 6. Such upper opening of such container 6 is numbered as element 7 in FIG. 1 while the small lower opening of such container 6 is numbered as element 8 in FIG. 1. In the preferred embodiment, the container 6 is a non-rigid cone. Collar 5 and container 6 are permanently affixed and together constitute upper element 10 as shown in FIG. 1. The relative positions of collar 5 and bung 4 are determined by use of threaded (or cam) elements numbered 9 and referred to at times herein as the threaded elements, such that collar 5 is raised or lowered relative to bung 4 by interaction of such threaded elements as collar 5 is rotated by a user as shown in FIG. 2. Container 6 is capable of holding a paper filter, perforated mesh cone, or other existing filtration media for the purpose of separating coffee grounds, loose tea, or other brewing media from the liquid used for brewing, hereinafter referred to as brewing liquid.

The device 100 of the instant invention allows a user to precisely and consistently control the rate of flow of brew liquid through the brewing media and filtration media, together referred to herein as brewing load, to achieve greater control of the flavor of the brewed beverage. In device 100 as shown in FIG. 1 is constructed of merely two elements, upper 10 and base 1, which two elements are susceptible of instant disassembly for easy and thorough cleaning of device 100.

In use, device 100 in its preferred embodiment is placed atop a vessel, generally a coffee cup or mug. Brewing liquid is added into upper opening 7 and begins to percolate through the brewing load previously placed into container 6. As shown in FIG. 2, a user rotates collar 5 in a circular counterclockwise manner of motion 11 to order to adjust the rate at which brewed liquid is permitted to exit the base 1 of device 100 downward as shown by directional arrow 12 and into a vessel, thus allowing the user to control the amount of time a given discreet portion of brewing liquid remains in contact with a given discreet brewing media.

Upper 10 is movably attached to base 1 by threaded elements 9 that allow device 100 to be adjusted, as well as for the complete and instant disassembly of the two components. Turning collar 5 in a specified clockwise or counterclockwise circular direction, such as circular clockwise motion 11, has the effect of raising upper 10 relative to base 1, and turning collar 5 in the opposite (clockwise) direction has the opposite effect, such that the rotational position of collar 5 and the relative height of upper 10 are linearly related. Peripherally located relative as to lower opening 8 is container 6 which includes an internal surface that is capable of mating to bung 4 to form a water-tight seal as sealing mechanism 2. A valve function is thus created between container 6 and bung 4 comprising sealing mechanism 2, so that the extent of the opening of the lower opening 8 is determined by the relative height of upper 10 to base 1 as it is adjusted by a user manipulating collar 5.

With upper 10 at the lowest possible height relative to base 1, the device shall be said to be fully closed such as in FIG. 1, and at the minimum adjustment, which restricts liquid flow in the direction 12 completely. At a certain relative height greater than said minimum adjustment, the device is fully open, as is referred to as maximum adjustment. The range of relative heights and related rotation of upper 10 between the minimum adjustment and maximum adjustments is referred to herein as the adjustment range. This adjustment range as well as the current setting is visibly indicated with markings on collar 5 (that in the preferred embodiment are numerical in nature); in other embodiments, detents can be set on threaded elements 9 to provide tactile feedback to a user for control of outflow and the related brewing results.

Importantly, in the preferred embodiment sealing mechanism 2 is shaped such that the rate of change of flow through the valve is linear for some portion of the adjustment range and nonlinear for another portion, allowing fine grained control throughout most of the adjustment range and rapid flow at or near the maximum adjustment. This acceleration of flow as the valve is opened provides for a greater means of control to determine the nature of the final brewed liquid. Base 1 can, in some embodiments, be constructed from non-rigid, non-slip material to prevent device 100 from sliding off or creating noises when placed atop the vessel.

What is claimed is:

1. A device for brewing a beverage comprising:
an upper element comprised of a container for a brewing load and a collar joined to the lower section of said container;
a sealing mechanism; and
a base having an opening controlled by said sealing mechanism, such base being removably joined to said collar of said upper element, wherein the rate of flow of heated liquid poured into said container exiting as a brewed liquid said through said lower opening is controlled by turning said collar.

2. The device of claim 1 in which said container is conical.

3. The device of claim 1 in which said container is constructed of non-rigid material.

4. The device of claim 3 in which said non-rigid material is selected from the group consisting of silicone, thermoplastic polyurethane, thermoplastic elastomer, thermoplastic rubber, and latex.

5. The device of claim 1 in which said collar and said base are removably joined by a threaded mechanism consisting of threads constructed in said collar and complementary threads constructed on said base.

6. The device of claim 5 in which said sealing mechanism is comprised of a bung protruding upward from said base and positioned over said lower opening and the internal surface of the lower end of said container whose relative positions are determined by adjustment of said threaded mechanism by turning said collar.

7. The device of claim 6 in which said lower opening is completely closed in the case in which said collar is adjusted using said threaded mechanism to reach its lowest position relative to said bung.

8. The device of claim 6 in which said lower opening is completely open in the case in which said collar is adjusted using said threaded mechanism to reach its highest position relative to said bung.

9. The device of claim 6 in which the rate of flow of said brewed liquid through said lower opening increases non-linearly as said collar is adjusted to move to a higher position relative to said bung.

10. The device of claim 1 in which said collar is marked with numbers indicating range of adjustment.

11. The device of claim 1 in which said threaded mechanism has detents to provide tactile feedback to a user adjusting said collar.

12. A method of brewing a single cup of brewed beverage to desired levels of strength, texture, flavor, and balance comprising the steps of:
attaching by use of threaded elements a non-rigid container that is permanently joined to a collar to a base having a lower opening over which protrudes a bung;
turning said collar to adjust said collar to its lowest position relative to said bung;
filling said container with a determined brewing load;
pouring water heated to a determined temperature over said brewing load in said container; and
adjusting the position of said collar relative to said bung in order to allow brewed liquid having desired levels of strength, texture, flavor, and balance to exit said container through said lower opening of said base into a single cup vessel.

13. The method of claim 12 in which said container is conical.

14. The method of claim 12 in which said container is constructed of non-rigid material.

15. The method of claim 14 in which said non-rigid material is selected from the group consisting of silicone, thermoplastic polyurethane, thermoplastic elastomer, thermoplastic rubber, and latex.
